(19) United States
(12) Patent Application Publication
(10) Pub. No.: US 2025/0142459 A1
(43) Pub. Date: May 1, 2025

(54) MULTI-LINK SETUP LINK RECOMMENDATION

(71) Applicant: HEWLETT PACKARD ENTERPRISE DEVELOPMENT LP, Spring, TX (US)

(72) Inventors: Gaurav Patwardhan, San Jose, CA (US); Eldad Perahia, Park City, UT (US)

(21) Appl. No.: 18/835,825

(22) PCT Filed: Feb. 13, 2023
(86) PCT No.: PCT/US2023/062477

§ 371 Date: Aug. 5, 2024

Related U.S. Application Data
(60) Provisional application No. 63/309,816, filed on Feb. 14, 2022.

(51) Int. Cl. H04W 48/16; H04W 76/15; H04W 84/12

(52) U.S. Cl. CPC H04W 48/16; H04W 76/15; H04W 84/12

(57) ABSTRACT

Systems and methods are provided for specifying a link recommendation. Such a link recommendation can recommend a particular multi-link operation (MLO) link between an access point (AP) multi-link device (AP MLD) and a non-AP MLD, such as a client device or station for use when exchanging data frames. Conventional usage of MLO can result in non-AP MLDs attempting to associate to a particular AP MLD over the same link, which can result in overloading of that link. This is because the implementation of MLO elevates the context of AP-client device/station association to a higher level, i.e., the device/MLD level, and the link on which data frames are sent or received between an AP MLD and a non-AP MLD s no longer a consideration/relevant. However, the transmission of link recommendations indicating links to use (or to avoid), avoids or lessens the risk that multiple non-AP MLDs attempting to associate to an AP MLD will overload or overuse the same link.

### CROSS-REFERENCE TO RELATED APPLICATIONS

This application claims priority to U.S. Patent Application Ser. No. 63/309,816 filed on Feb. 14, 2022, which is hereby incorporated by reference in its entirety.

### BACKGROUND

Generally, in a Wireless Local Area Network (WLAN), one or more Access Points (APs) may be deployed. An AP is a network device that allows wireless client devices such as laptops, personal computers, smartphones, etc. to connect to the WLAN to exchange data within the network.

The IEEE 802.11 protocol denotes a set of interface standards developed by the IEEE 802.11 committee for short-range communications in networks such as WLANs. For example, the devices that implement the IEEE 802.11 protocol may have both 2.4 GHz and 5 GHz radios for transmitting and receiving data and management frames between devices with similar radio configurations.

Using this or other standards, various access methods are available to enable network communications. One such method is a Carrier Sense Multiple Access (CSMA), where a network device can sense and transmit data to other network devices. For example, the transmitting network device may sense a channel and check whether the channel is idle or busy (e.g., using a wait for silence method). If the channel is busy, the transmitting network device may wait until the channel becomes idle. When the channel is not busy, the transmitting network device may immediately transmit data, control, or management frames using a persistent CSMA method, or transmit data, control, or management frames after a predetermined amount of time using a non-persistent CSMA method. These and other communication methods are available.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates an example network deployment or environment in which some examples of the disclosed technology may be used.

FIG. 2 illustrates a conventional example of multi-link operation between an AP and a client device.

FIG. 3 illustrates a Link ID subfield of a multi-link information element.

FIG. 4 illustrates the Link ID subfield of FIG. 3, where a reserved bit is used to carry a link recommendation in accordance with some examples of the disclosed technology.

FIG. 5 is an example computing component that may be used to implement various features of examples of the disclosed technology.

FIG. 6A illustrates one example scenario in which examples of the disclosed technology may be used.

FIG. 6B illustrates the example scenario of FIG. 6A, when a link recommendation is provided in accordance with examples of the disclosed technology.

FIG. 6C illustrates the example scenario of FIG. 6A, when a link recommendation is provided in accordance with other examples of the disclosed technology.

FIG. 6D illustrates the example scenario of FIG. 6A, when a link recommendation is provided in accordance with still other examples of the disclosed technology.

FIG. 7A is an example scenario in which examples of the disclosed technology may be used.

FIG. 7B illustrates the example scenario of FIG. 7A, when a link recommendation is provided in accordance with examples of the disclosed technology.

FIG. 8A is an example scenario in which examples of the disclosed technology may be used.

FIG. 8B illustrates the example scenario of FIG. 8A, when a link recommendation is provided in accordance with examples of the disclosed technology.

FIG. 9 is a block diagram of an example computer system in which various of the embodiments described herein may be implemented.

The figures are not exhaustive and do not limit the present disclosure to the precise form disclosed.

### DETAILED DESCRIPTION

Different physical layer and MAC layer enhancements have been proposed to improve the standard protocol definition of the basic CSMA scheme, for example, in order to increase throughput, implement wider channel bandwidth, support other types of network devices, decrease power consumption while maintaining operability, or other technical enhancements. One such enhancement between two network devices is to increase the number of available communication channels from one channel to two channels using multi-link operations (MLO).

MLO is a particular feature of the IEEE 802.11be Extremely High Throughput (EHT) Wi-Fi 7 standard that allows network devices, like access points (APs) and client devices, the ability to transmit and receive data from the same traffic flow over multiple radio channels. For example, a first network device (e.g., the AP, also referred to in this context as an AP multi-link device (MLD)) may implement multiple radios, like a 2.4 GHz radio and 5 GHz radio, and each of these radios may communicate with similar or overlapping frequency radios on a second network device (e.g., the client device). In some examples, the networking devices may comprise non-overlapping radios to offer additional frequency transmission options. For example, the plurality of APs may comprise a 2.4 GHz radio and a non-2.4 GHz radio (e.g., 5 GHz or 6 GHz), or a 5 GHz radio and an non-5 GHz radio (e.g., 2.4 GHz or 6 GHz), or a 6 GHz radio and a non-6 GHz radio (e.g., 2.4 GHz or 5 GHz). In another example, the plurality of APs may comprise a tri-radio option, including one or more APs with three radios, 2.4 GHz radio, 5 GHz radio, and 6 GHz radio.

MLO also allows a non-AP MLD to send data to or receive data from an AP MLD over multiple links. As such, all links of a multi-link entity that reside in a single hardware device can be used for MLO transmissions. For example, a first set of frames (e.g., data frames) may be transmitted from a first network device to a second network device on a first radio channel and a second set of frames (e.g., control frames) may be transmitted from the first network device to the second network device on a second radio channel.

Because a non-AP MLD can send/receive frames over multiple links to/from an AP MLD simultaneously, the non-AP MLD's peak throughout naturally increases. Moreover, because the non-AP MLD can contend on multiple links independently, the average channel access delay is reduced, which in turn, reduces/improves latency. It should be noted that only a single association (to an AP on a radio level) and security context (comprising a set of security attributes and rules that are to be in effect during a communication session) between the non-AP MLD and an AP MLD. Thus, a single encryption key is derived by both the AP MLD and the non-AP MLD to be used for encrypting/decrypting frames exchanged therebetween.

To enable MLO, as noted above, the concept of an MLD was introduced. An MLD is a device capable of transmitting and receiving data on multiple different communication links/channels, where each link is characterized by a logically independent PHY/MAC component, but higher layers perceive the MLD as a single network entity. Each link is a distinct physical operating frequency across which a radio of an MLD can communicate with a radio of a device, which itself may be an MLD. MLDs include devices with a single physical radio as well as devices having multiple physical radios. MLDs with a single physical radio can operate on multiple different links (i.e., different physical frequencies) by switching the radio to an appropriate frequency band. MLDs having multiple physical radios, on the other hand, can operate the multiple radios in different bands simultaneously. The terms link, communication link, channel, communication channel, or some other variant thereof may be used interchangeably herein to refer to a distinct physical operating frequency on which data exchange can occur.

Further to the above, and similar to conventional client devices or stations, a non-AP MLD undergoes an association procedure with an AP before the non-AP MLD can send or receive data frames to/from an AP MLD. At a high level, this association procedure entails exchanging a plurality of frames between the AP MLD and the non-AP MLD, e.g., an authentication request and response, an association request and response, an optional 4-way key derivation handshake procedure, and so on.

However, the MLO feature elevates the context of AP-client association to a higher logical level. That is, the association context, which as alluded to above, associates radios of the non-AP MLD and the AP MLD, no longer exists. For example, whereas before the advent of MLO, a client device's 2.4 GHz radio would be associated to an AP's 2.4 GHz radio, now, the link on which data frames are sent between an AP MLD and non-AP MLD is irrelevant. Instead, the association context now exists on the device level, i.e., between the AP MLD and non-AP MLD, regardless of which radio(s) are being used (recalling that MLO allows a non-AP MLD to send data to or receive data from an AP MLD over multiple links).

This can present certain issues. For example, in the event of an AP MLD reboot or reset, all wireless clients, such as non-AP MLDs, will attempt to associate or re-associate to an AP MLD over a single, particular link. For example, if an AP MLD is rebooted, all or multiple non-AP MLDs previously associated to now-rebooted AP MLD may attempt to associate to now-rebooted AP MLD over the same 2.4 GHz link because that 2.4 GHz link was discovered by all/multiple non-AP MLDs. This has the potential to flood the 2.4 GHz link with frames, which is undesirable.

Accordingly, examples of the disclosed technology are directed to avoiding the potential for overloading or overutilizing a particular link when MLO is enabled or is in use. Examples of the disclosed technology operate to recommend a link over which a non-AP MLD may associate to an AP MLD. This link recommendation can be effectuated by including or appending a Link ID information element (IE) (or some other equivalent or appropriate IE currently in use or later-implemented) with which a non-AP MLD can use to initiate its association and multi-link setup procedures. For example, the Link ID IE has four reserved bits, one of which may be used to indicate that the link being advertised by the beacon is either a recommended link for association and multi-link setup purposes or a non-recommended link for association and multi-link setup purposes. Upon receipt/parsing such a Link ID IE (or other appropriate/similar IE) in which a recommended link is identified, a receiving non-AP MLD may associate to the advertising AP MLD over the recommended link. Upon receipt/parsing such a Link ID IE (or, again, another appropriate or similar IE), in which a non-recommended link is identified, the receiving non-AP MLD will attempt to avoid associating to the advertising AP MLD over the non-recommended link.

Technical improvements are realized throughout the disclosure. For example, by transmitting information regarding recommended/non-recommended links of an AP MLD, the number of times where non-AP MLDs attempt to associate to the AP MLD over the same link can be reduced. In this way, the aforementioned problem of overloading/overutilizing a particular AP MLD link can be avoided or at least mitigated (the number of instances that a link is overloaded with frames, e.g., from non-AP MPDs attempting to associate to that link simultaneously can be reduced).

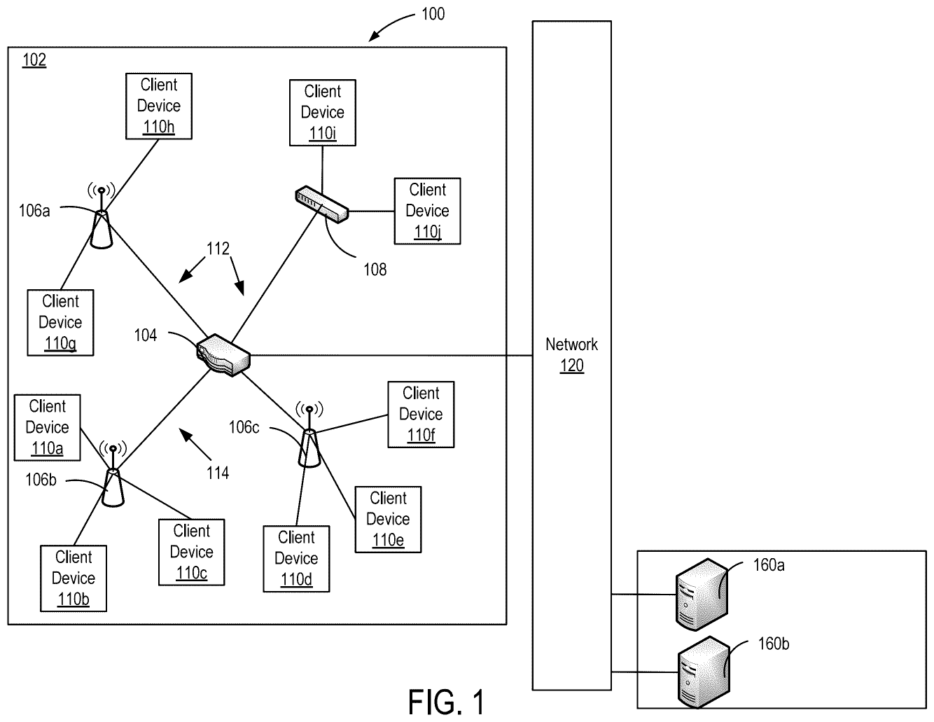

Before describing examples of the presently disclosed technology in detail, it is useful to describe an example network deployment that may include one or more components/elements with which various embodiments may operate. FIG. 1 illustrates one example of a network deployment 100 that may be implemented for an enterprise/organization, such as a business, educational institution, governmental entity, healthcare facility or other organization. This diagram illustrates an example of a configuration implemented with an organization having multiple users (or at least multiple client devices 110) at a geographical site 102.

The geographical site 102 may include a primary network, which can be, for example, an office network, home network or other network installation. The geographical site 102 network may be a private network, such as a network that may include security and access controls to restrict access to authorized users of the private network. Authorized users may include, for example, employees of a company at geographical site 102, residents of a house, customers at a business, and so on.

In the illustrated example, the geographical site 102 includes a controller 104 in communication with the network 120. The controller 104 may provide communication with the network 120 for the geographical site 102, though it may not be the only point of communication with the network 120 for the geographical site 102. A single controller 104 is illustrated, though the geographical site 102 may include multiple controllers and/or multiple communication points with network 120. In some examples, the controller 104 communicates with the network 120 through a router (not illustrated). In other examples, the controller 104 provides router functionality to the devices in the geographical site 102.

A controller 104 may be operable to configure and manage network devices, such as at the geographical site 102. The controller 104 may be operable to configure and/or manage switches, routers, access points, and/or client devices connected to a network. The controller 104 may itself be, or provide the functionality of, an access point.

The controller 104 may be in communication with one or more switches 108 and/or wireless APs 106a-c. Switches 108 and wireless APs 106a-c provide network connectivity to various client devices 110a-j. Using a connection to a switch 108 or AP 106a-c, a client device 110a-j may access network resources, including other devices on the (geographical site 102) and the network 120.

Examples of client devices may include: desktop computers, laptop computers, servers, web servers, authentication servers, authentication-authorization-accounting (AAA) servers, Domain Name System (DNS) servers, Dynamic Host Configuration Protocol (DHCP) servers, Internet Protocol (IP) servers, Virtual Private Network (VPN) servers, network policy servers, mainframes, tablet computers, e-readers, netbook computers, televisions and similar monitors (e.g., smart TVs), content receivers, set-top boxes, personal digital assistants (PDAs), mobile phones, smart phones, smart terminals, dumb terminals, virtual terminals, video game consoles, virtual assistants, Internet of Things (IOT) devices, and the like.

Within the geographical site 102, a switch 108 is included as one example of a point of access to the network established in geographical site 102 for wired client devices 110i-j. Client devices 110i-j may connect to the switch 108 and through the switch 108, may be able to access other devices within the network deployment 100. The client devices 110i-j may also be able to access the network 120, through the switch 108. The client devices 110i-j may communicate with the switch 108 over a wired 112 connection. In the illustrated example, the switch 108 communicates with the controller 104 over a wired 112 connection, though this connection may also be wireless.

Wireless APs (which may be AP MLDs) 106a-c are included as another example of a point of access to the network established in geographical site 102 for client devices 110a-h. Each of APs 106a-c may be a combination of hardware, software, and/or firmware that is configured to provide wireless network connectivity to wireless client devices 110a-h. In the illustrated example, APs 106a-c can be managed and configured by the controller 104. APs 106a-c communicate with the controller 104 and the network over connections 112, which may be either wired or wireless interfaces. An AP generally refers to a networking device that allows a wireless client device to connect to a wireless network. An AP can include a processor, memory, and I/O interfaces, including wired network interfaces such as IEEE 802.3 Ethernet interfaces, as well as wireless network interfaces such as IEEE 802.11 Wi-Fi interfaces, although examples of the disclosure are not limited to such interfaces. An AP can include memory, including read-write memory (i.e., volatile memory), and a hierarchy of persistent memory (i.e., non-volatile memory) such as ROM, EPROM, and Flash memory. Moreover, as used herein, an AP may refer to receiving points for any known or convenient wireless access technology which may later become known. Specifically, the term AP is not intended to be limited to IEEE 802.11-based APs.

The network 120 may be a public or private network, such as the Internet, or other communication network to allow connectivity with geographical site 102, as well as access to servers 160a-b. The network 120 may include third-party telecommunication lines, such as phone lines, coaxial cable, fiber optic cables, satellite communications, cellular communications, and the like. The network 120 may include any number of intermediate network devices, such as switches, routers, gateways, servers, and/or controllers, which are not directly part of the network deployment 100 but that facilitate communication between the various parts of the network deployment 100, and between the network deployment 100 and other network-connected entities.

As alluded to above, MLO allows a non-AP MLD to send/receive data from an MLD over multiple links. These transmissions may correspond to particular protocol formatting. For example, various radio settings are available for the 2.4 GHz and 5 GHz radios implemented at each AP or other network device (used interchangeably). For example, the network device can operate in accordance with a default profile or create a new profile that corresponds with the rules subject to a protocol (e.g., IEEE 802.11a, 802.11g, 802.11n, etc.). The profiles may comprise a manual identification of a channel for each AP group, create separate “dot11” profiles for each network device group, or assign a different transmission channel for each profile. For example, one network device group could have an IEEE 802.11a profile that uses channel 36 and an IEEE 802.11g profile that uses channel 11, and another network device group could have an IEEE 802.11a profile that uses channel 40 and an IEEE 802.11g profile that uses channel 9.

In order to implement these communications, each network device may implement a Media Access Control (MAC) Service Access Point (SAP) or other interface controller component. The MAC SAP is an interface implemented as a physical or virtual component of a physical or virtual network device (e.g., an AP or other client device). Using the MAC SAP, devices or users can identify a particular user service that sends and receives a particular class of data. The data may be associated with a service request across multiple, different layers of the Open Systems Interconnection (OSI) model for the network device. As an example, the MAC layer (e.g., part of the second or data link layer that controls access to the physical transmission medium in local networks) can request services from the physical layer (e.g., part of the first layer that defines electrical and physical specifications for the device) in a single network device. The address for requesting services across the layers can use a Network Service Access Point (NSAP) address or an Asynchronous Transfer Mode (ATM) can use Transport (TSAP), Session (SSAP) or Presentation (PSAP) Service Access Points to specify a destination address for a connection. The SAP can differentiate at any of the OSI layers between multiple services at that layer provided by the network device.

The MAC SAPs may support dual-band parallel architectures aggregated across 2.4 GHz, 5 GHz, or 6 GHz bands using stored usage rules and particular management specifications for multiple bands. For example, the IEEE 802.11 protocol recommends two multi-band MAC architectures to provide different technical support for multi-band operations, allowing for various management/data plane renegotiations for faster session transfer over multiple bands and/or channels concurrently or non-concurrently.

Other iterations of the radios and sub-bands may be implemented without diverting from the essence of the disclosed technology.

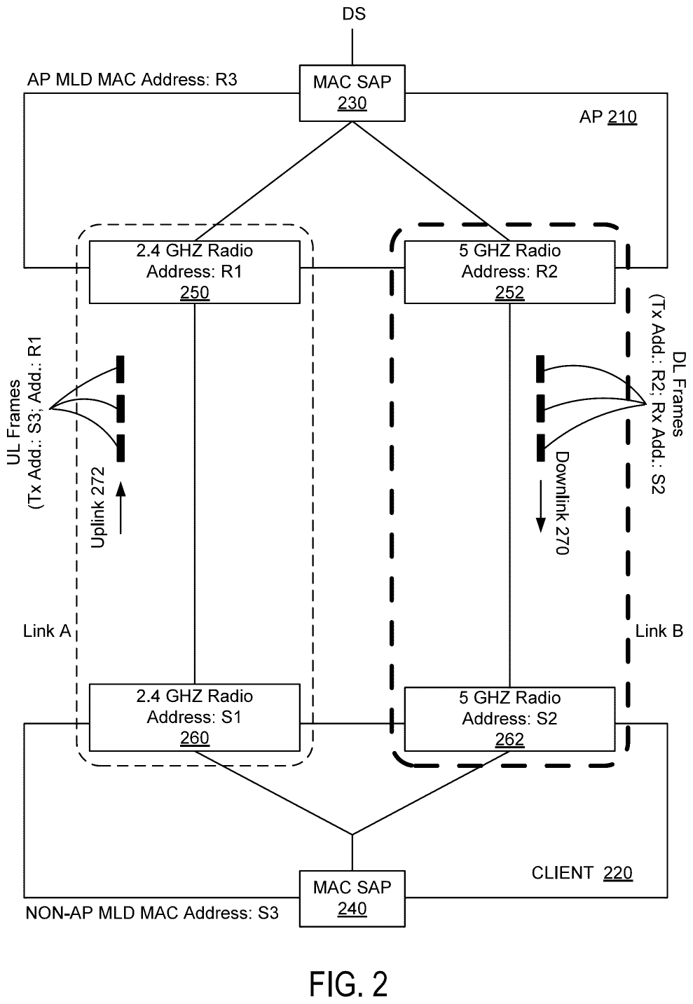

FIG. 2 is an example system with two network devices, each with a MAC SAP, in accordance with some examples of the disclosure. In this example, an AP MLD 210 and a non-AP MLD (also interchangeably referred to as a “client device”) 220 are provided. Other network devices besides AP MLDs and client devices may be implemented without diverting from the essence of the disclosure, including a switch, router, or other network device(s).

Each of AP MLD 210 and non-AP MLD 220 comprises a MAC SAP 230, 240, respectively for providing an interface that devices or users can access functionality in the backend system. For example, AP MLD 210 comprises a AP-based MAC SAP 230, and client device 220 comprises a client-based MAC SAP 240.

Each of the network devices in this illustration comprise at least two radios, including 2.4 GHz and 5 GHz radios, although any radio frequency may be supported by this disclosure. For example, AP MLD 210 includes first radio 250 and second radio 252, and non-AP MLD 220 includes first radio 260 and second radio 262

In the illustrated example, AP 210 may transmit one or more data frames 270 in a downlink to client device 220 (over link B). Particularly, AP 210 may use second radio 252 (operating at 5 GHz) to transmit data frames to second radio 262 (also operating at 5 GHz) of client device 220. The transmitter address at AP 210 may correspond with “R2” and the receiver address at client device 220 may correspond with “S2.”

From a client device 220 perspective, client device 220 may not determine that the downlink frames are coming from one or two AP devices, since a single AP (e.g., AP 210) comprises two radios (e.g., first radio 250 and second radio 252) operating at two different frequencies. Client device 220 may be capable of receiving the transmissions at two frequencies corresponding with each of the two radios. The wireless communication connection may be initiated with the discovery and connection on the radio basis rather than with the AP device (as alluded to above).

Additionally, client device 220 may transmit data frames in the uplink direction 272 on/over link A, established between first radio 250 of AP MLD 210 and first radio 260 of client device 220. It should be understood that AP MLD 210 may transmit data frames in the downlink direction 270 over both links A and B, e.g., some data frames can be sent/received by AP MLD 210 and client device 220, respectively, over each of their 5 GHz radios 252/262, while some data frames can be sent/received by AP MLD 210 and client device 220, respectively, over each of their 2.4 GHz radios 250/260. In some examples, one set of corresponding AP MLD and client device radios may transmit data frames in a downlink direction during a first time period, while the same set of corresponding AP MLD and client device radios may be used for uplink transmissions during a second time period. In other words, reordering/transmitting data frames on either or both of links A and B can be performed to effectuate a variety of different transmission/reception scenarios involving one or both (or more, if an AP MLD and non-AP MLD is so-configured).

As previously noted, a single association and security context exist between AP MLD 210 and client device 220, meaning a single encryption key can be derived by both MLDs to be used for encryption and decryption of the data frames transmitted/received therebetween. As also previously noted, because MLO elevates the context of AP-client association to a higher level, i.e., the device/MLD level, the link on which data frames are sent or received between AP MLD 210 and client device 220 is no longer a consideration/relevant. Thus, to avoid possibly overloading a particular link, such as either of links A or B, AP MLD 210 may transmit a recommended link over which client device 220 may attempt to associate to AP MLD 220, and over which multi-link setup procedures can be performed.

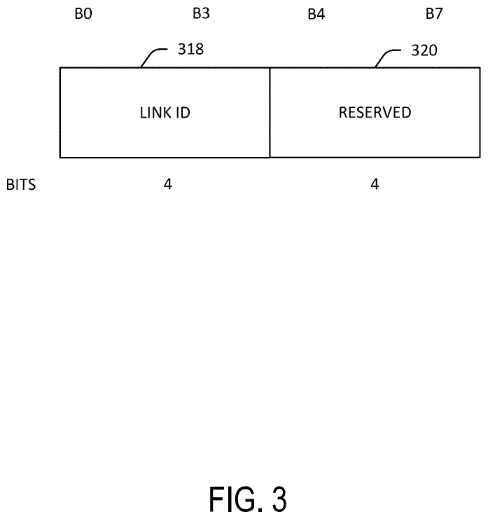

FIG. 3 illustrates an example element/information element (IE) subfield in which a link recommendation may be included. The illustrated example is that of a Link ID subfield 318 and a set of reserved bits 320. In the illustrated example, as specified in the 802.11be standard (Draft 1.4), the Link ID subfield includes a first set of bits 318 (four bits, B0-B3), and a set of reserved bits that also numbers four bits (B4-B7). A Link ID subfield can be thought of as a pointer used to reference or identify an existing connection/link on which a device is operating. It should be noted that the Link ID subfield is only an example of one subfield (associated with one IE) that may be used for recommending a link over which a non-AP MLD should perform association and multi-link setup procedures. The present disclosure contemplates that other subfields or IEs known/used now in the standard (or later-discovered or used) may be leveraged to present a recommended link.

Various IEs may be included in different management frames so that devices, such as APs and client devices (or other network devices) may exchange information regarding their respective capabilities and operational parameters. As indicated above, a link recommendation can be provided that indicates whether or not the link specified in/by the Link ID is recommended for use or is not recommended for use. Commensurate with the introduction of MLO in the 802.11be standard, an IE, referred to as a multi-link element (MLE), was designed to be a common element to the different management actions (e.g., discovery and setup). Typically, MLEs exist as two variants, the first being a “basic” MLE type, intended for use with (to be promulgated by) beacon frames transmitted by an AP MLD. The second type of MLE can be referred to as a “multi-link request/response” type, for use during the multi-link setup procedure. Typical 802.11 discovery mechanisms may be used to discover, e.g., an AP/AP MLD and its capabilities, e.g., through active or passive scanning.

An MLE IE may have two parts: a common information subfield that carries information that is common to all links of an MLD, and a link specific subfield(s), each of which carries information specific to that link(s). A link that is being specified is given by the aforementioned Link ID subfield of an MLE that is included in different types of frames (which themselves relate to specific management and control functions). There are some variants of MLE, and the usage/interpretation of MLE varies with the context in which it is included in different frames. That being said, the Link ID subfield is included in most of the link-specific subfields in an MLE (as mentioned above). Ultimately, the Link ID subfield identifies a link of an AP MLD specified in an MLE IE, and as modified in accordance with some examples, the Link ID subfield can also be used to indicate whether or not the specified link is a recommended link or not.

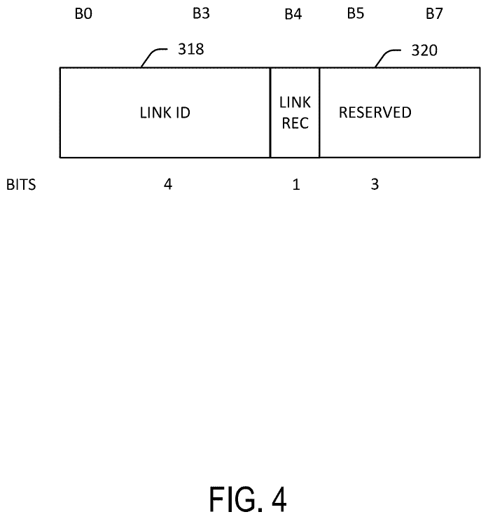

FIG. 4 illustrates the Link ID subfield of FIG. 3, but in accordance with some examples of the disclosed technology, one of the previously-reserved bits can contain link recommendation information, e.g., bit B4, can be used to hold information regarding a link recommendation. As illustrated in FIG. 4, Link ID information remains as bits B0-B3, while bits B5-B7 remain as reserved bits. It should be noted, however, that any of the reserved bits may be used. Various ways to indicate a link recommendation may be used, but in one example, a value of 0 in bit B4 can signify to a receiving non-AP MLD, such as client device 220 (FIG. 2), that the link identified by the Link ID subfield (bits B0-B3) are not recommended for association and multi-link setup purposes. On the other hand, receipt by a non-AP MLD, such as client device 220, of a B4 bit with a value of 1, indicates to the receiving non-AP MLD that the link specified/identified by the Link ID subfield is recommended for the non-AP MLD to associate to the AP MLD, e.g., AP MLD 210, or over which to perform multi-link setup procedures. It should be understood that these values can vary so long as they can be used to provide a link recommendation.

In accordance with various examples of the disclosed technology, the link recommendation information (bit) can specify whether or not a link specified in the Link ID subfield is recommended for use by a non-AP MLD for associating to the AP MLD or for multi-link setup procedures. As discussed above, the Link ID subfield, and now, the link recommendation subfield, can be broadcast or transmitted to a network vis-a-vis a beacon transmitted by the AP MLD, and a receiving non-AP MLD can associate to/perform multi-link setup over a recommended link. Again, providing a link recommendation regarding whether or not to associate to/select a link over which to perform multi-link setup procedures can lessen the chance of overloading a particular link.

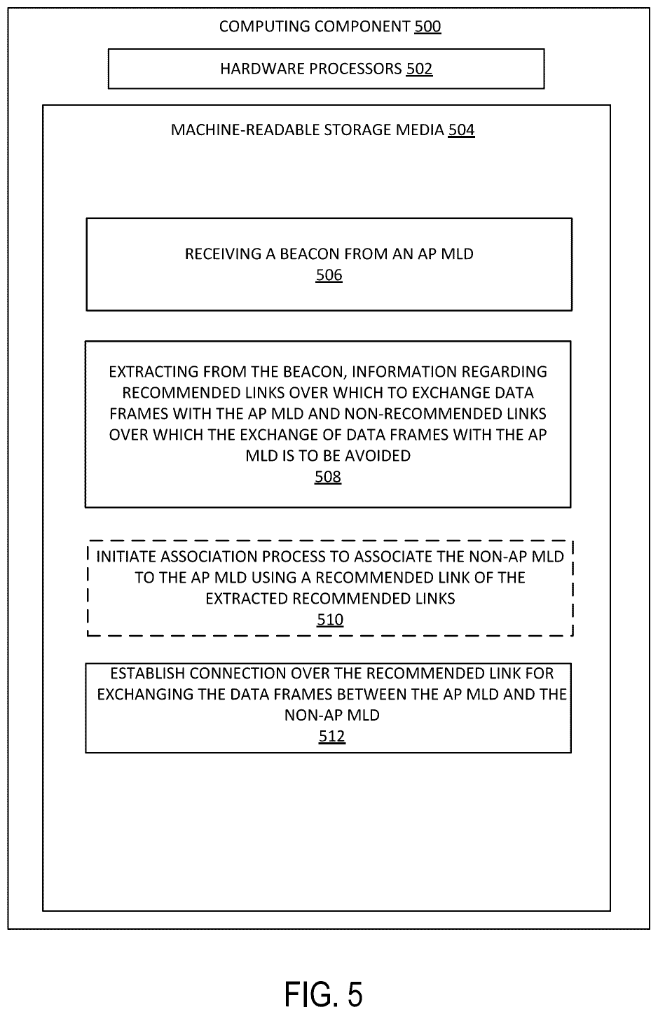

FIG. 5 illustrates an example computing component that may be used to implement the dynamically modular and customizable computing systems in accordance with various embodiments. Referring now to FIG. 5, computing component 500 may be, for example, a server computer, a controller, or any other similar computing component capable of processing data. In the example implementation of FIG. 5, the computing component 500 includes a hardware processor 502, and machine-readable storage medium for 504.

Hardware processor 502 may be one or more central processing units (CPUs), semiconductor-based microprocessors, and/or other hardware devices suitable for retrieval and execution of instructions stored in machine-readable storage medium 504. Hardware processor 502 may fetch, decode, and execute instructions, such as instructions 506-512, to control processes or operations for implementing the dynamically modular and customizable computing systems. As an alternative or in addition to retrieving and executing instructions, hardware processor 502 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 504, may be any electronic, magnetic, optical, or other physical storage device that contains or stores executable instructions. Thus, machine-readable storage medium 804 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 804 may be a non-transitory storage medium, where the term “non-transitory” does not encompass transitory propagating signals. As described in detail below, machine-readable storage medium 804 may be encoded with executable instructions, for example, instructions 506-512.

Hardware processor 502 may execute instruction 506 to receive a beacon from an AP MLD. As discussed above, examples of the disclosed technology are directed to selective use of a link in an MLO mode of operation. In particular, a link recommendation may be specified in a bit of the Link ID subfield defined by the 802.11 standard (or other IE), where the link recommendation is sent via beaconing from an AP MLD to one or more non-AP MLDs. Such non-AP MLDs may receive the beacon with link recommendation information during, e.g., discovery, where the non-AP MLDs are discovering APs to which they may associate (after a reboot, or upon power on, etc.). As will be described in greater detail below, link recommendations may be sent on or with a variety of other transmissions or messages, i.e., link recommendation information is not limited to being transmitted over an AP MLD beacon.

Hardware processor 502 may execute instruction 508 to extract, from the beacon, information regarding recommended links over which to exchange data frames with the AP MLD and non-recommended links over which the exchange of data frames with the AP MLD is to be avoided. As discussed above, an MLE IE includes a Link ID subfield through which a link may be identified. The AP MLD, by virtue of transmitting beacons, advertises the link which is the result of different device radio links being tied together to form an multi-link “virtual” device service set (SSID), to which link numbers or IDs are assigned. Referring back to FIG. 2, for example, link A between the respective 2.4 GHz radios of AP MLD 210 and non-AP MLD 220 may be advertised in a beacon, as would be Link B (reflecting a link between the 5 GHz radios of AP MLD 210 and non-AP MLD 220). A reserved bit of the Link ID subfield, referred to as a link recommendation subfield, may be used to indicate a recommended or non-recommended link. That is, the link advertised by the AP MLD in the Link ID subfield may be deemed to be recommended or non-recommended depending on the value of the link recommendation subfield.

Hardware processor 502 may execute instruction 510 to initiate an association process to associate the non-AP MLD to the AP MLD using a recommended link of the extracted recommended links. As will be described in greater detail below, and as alluded to above, non-AP MLDs engage in typical association procedures to associate to an AP MLD. Typical association procedures may entail, once a beacon from an AP MLD has been received, the non-AP MLD sending a probe request, waiting for/receiving a probe response, sending an association request, waiting for/receiving an association response, and possibly engaging in a 4-way key exchange. In this example, the link recommendation may be sent in at least a beacon from the AP MLD, informing a receiving non-AP MLD to use (or avoid using) a particular link for association and multi-link setup procedures. Accordingly, the non-AP MLD can engage in, e.g., the association request/response messaging over a recommended link.

Hardware processor 502 may execute instruction 512 to establish a connection over the recommended link for exchanging data frames between the AP MLD and the non-AP MLD. In other words, once a recommended link has been determined by the non-AL MLD (by way of receiving and parsing beacons with link recommendations), the non-AP MLD can attempt to associate to the AP MLD over such a recommended link. For example, an association request message can be sent from the non-AP MLD to the AP MLD over the recommended link. The AP MLD may send an association response to the non-AP MLD over that same recommended link.

As will be described below (and illustrated in further drawings), establishment of a connection over a recommended link and the exchange of data frames can occur in a variety of contexts (e.g., the aforementioned association context, multi-link setup context, and so on). It can be appreciated as well, that when it comes to these various contexts, performance of certain operations or procedures need not encompass the performance of all, e.g., sub-operations or sub-procedures that make up the overall operations/procedures. For example, only a portion of an overall operation may be associated with a recommended link, where perhaps an initial set of sub-operations of the overall operation may not be associated with a recommended link, whereas a subsequent set of sub-operations is, based on a recommended link, performed over that recommended link. Moreover, the examples of link recommendations set forth herein are not meant to be limiting in any way. The disclosed technology contemplates link recommendation usage in a variety of scenarios as desired, save for instances where the use of link recommendations may run afoul of operations with certain timing constraints, or in the case of certain, e.g., atomic, operations that are to be performed on the same link (where the context can't be switched to another/different link). As illustrated in FIG. 5, initiation of an association process may be a scenario during which a link recommendation may be used. However, link recommendations can be sent/used in other contexts as well, whether after association or outside of the association process. For example, and as noted above, examples of the disclosed technology can recommend links for use during multi-link setup procedures, e.g., for establishing a connection(s) for the exchange of data frames.

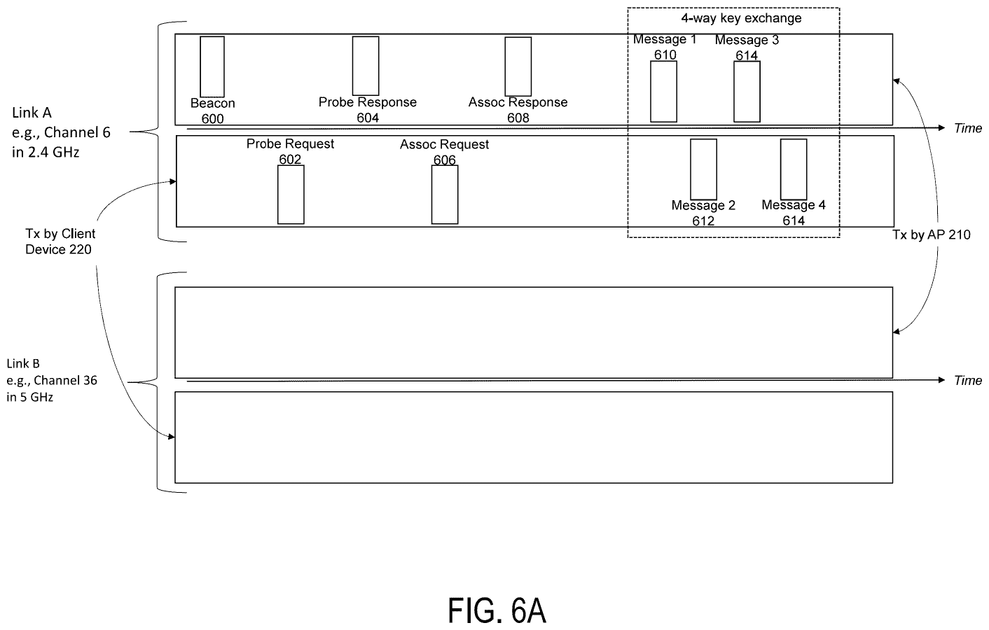

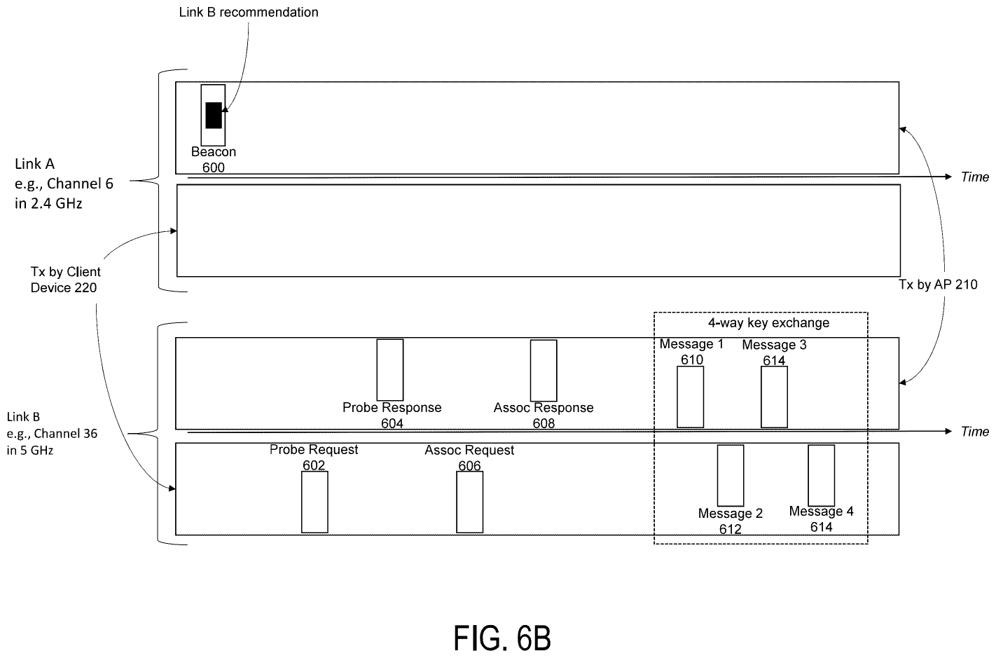

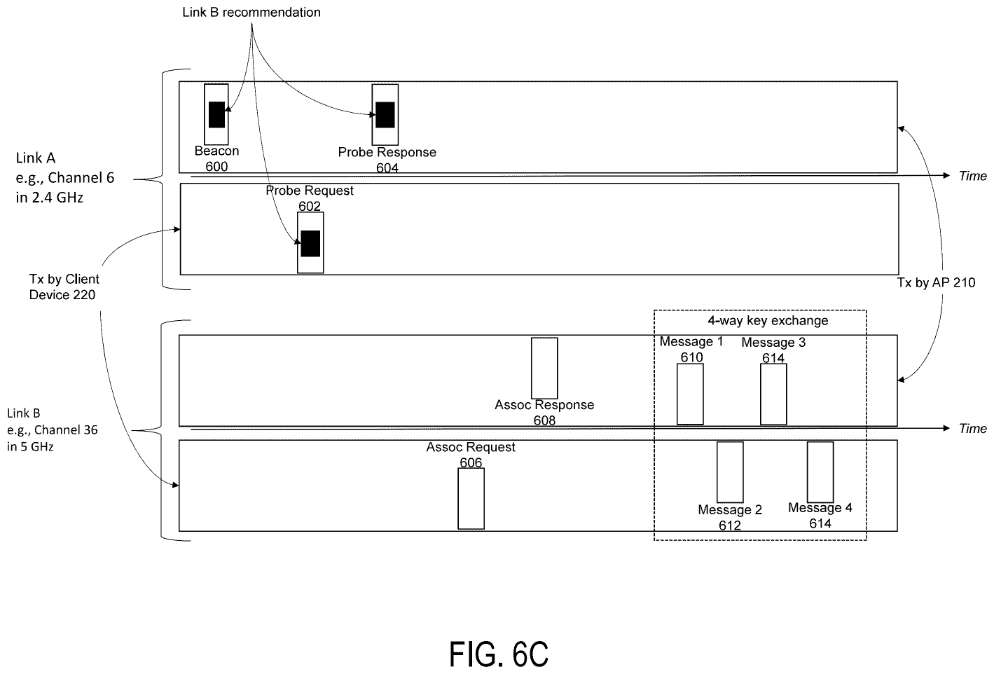

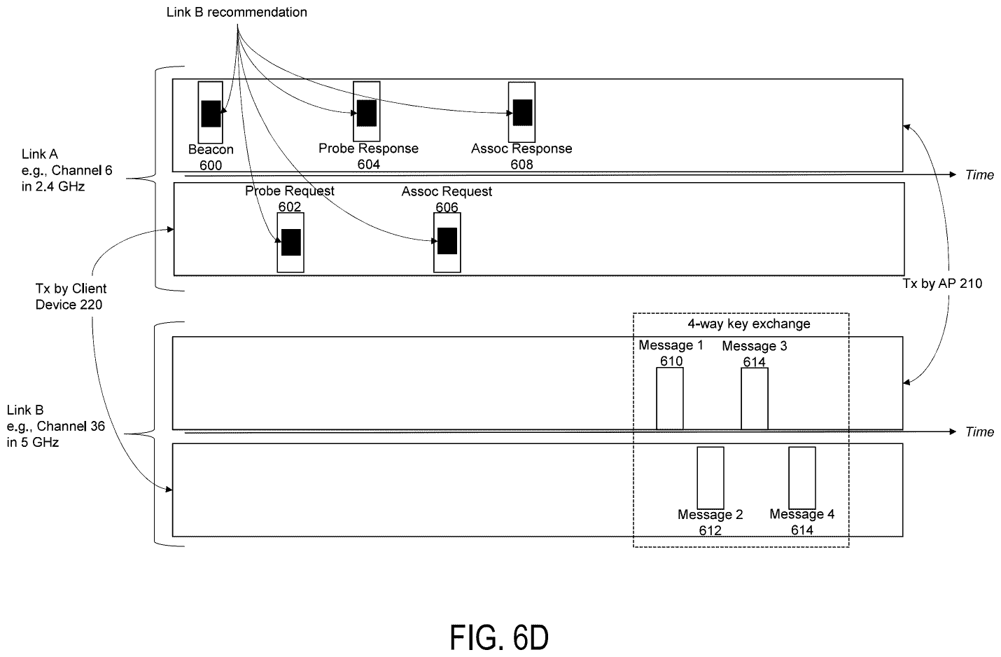

FIG. 6A illustrates an example of an association procedure in which a client device, such as a non-AP MLD, and an AP, such as an AP MLD, may engage to associate the non-AP MLD to the AP MLD. Two links between the AP 210 and the client device 220 are illustrated, i.e., links A and B. Link A may correspond to the 2.4 GHz frequency band which is used for communication between the 2.4 GHz radios of the AP 210 and the client device 220 (see, FIG. 2), and in the illustrated example, a particular channel, channel 6, may be used in the 2.4 GHz frequency band. Link B may correspond to the 5 GHz frequency band which is used for communication between the 5 GHz radios of the AP 210 and client device 220, and in particular, channel 36 of the 5 GHz frequency band. It should be understood that the specific channel used for communications need not be limited to a specific channel(s). Again, examples of the disclosed technology are premised on a recommended link, rather than channels of a link.

As noted above, and as illustrated in FIG. 6A, a typical association operation involves an AP, such as AP 210, transmitting a beacon 600 advertising its existence to the network(s) in which it is operating, and relaying information that client devices may need to connect to the network. One or more client devices, such as client device 220, may discover AP 210 by way of beacon 600. Client device 220 may send a probe request 602 to discover networks (e.g., 802.11 networks) in its vicinity. Probe request 602 may advertise information regarding client device 220, e.g., its supported data rates, and its 802.11 capabilities. AP 210 may respond with a probe response 604. AP 210, upon receiving probe request 602, may check to see if client device 210 has a common supported data rate. If so, AP 210 can send probe response 604 to client device 220 advertising AP 210's SSID, supported data rates, encryption types (if needed), and 802.11 capabilities of AP 210.

It should be noted that in some scenarios, authentication requests/responses are exchanged between APs and client devices to validate the client devices. Such authentication requests/responses are not shown in FIG. 6A.

Once client device 220 determines which AP it would like to associate to, in this case, say AP 210, client device 210 sends an association request 606 to AP 210 that can contain a chosen encryption type(s) and other 802.11 capabilities of client device 210. If the elements of association request 606 match the capabilities of AP 210, AP 210 can create an association ID for client device 220, and can transmit an association response 608, which can be a message granting network access to client device 220. In some scenarios, a 4-way handshake or key exchange can occur, which provides encryption for the data to be sent between client device 220 and AP 210. The 4-way handshake, which includes message 1 610, message 2 612, message 3 614, and message 4 616, uses a pass key and data concatenation to effectuate data encryption. At this stage, a connection between AP 210 and client device 220 can be/is established, and client device 220 is associated to AP 210, and data frames can be transmitted therebetween.

As can be appreciated in FIG. 6A, all communications (exchange of data) occurs on a single link between AP 210 and client device 220, in this example, link A. However, inclusion of an MLE in a beacon, such as beacon 600 of FIG. 6B, that also includes a link recommendation to use a particular link, suggests to client device 220 to use the recommended link for MLD-level procedures, such as the aforementioned authentication, and block acknowledgements for non-AP MLDs.

Referring to FIG. 6B, a scenario is illustrated where beacon 600, transmitted by AP 210 on link A, includes a link recommendation in the Link ID subfield, recommending a link for use, in this instance, link B. Following receipt of beacon 600, and parsing beacon 600 to determine link B is a recommended link, client 210 can continue by transmitting its probe request 602, association request 606, and messages 610/614 of the 4-way exchange on link B. Likewise, AP 210 can exchange data frames with client device 220, also using link B. That is, AP 210 may transmit probe response 604 over link B in response to probe request 602, as well association response 608, and its respective portion of the 4-way key exchange messages, i.e., messages 612/616. In this way, not all non-AP MLDs attempting to associate to an AP MLD will attempt to associate over the same link, avoiding overloading/overburdening any particular link.

Referring to FIG. 6C, a scenario is illustrated where again, beacon 600, transmitted by AP 210 on link A, includes a link recommendation in the Link ID subfield, recommending a link for use, in this instance, link B. In this scenario, probe request 602 and probe response 604 may also include a link recommendation to a particular link, in this case, link B. It should be understood that the Link ID subfield, that includes the link recommendation is sent on every/all beacons transmitted by AP 210. Here, association request 606, association response 608, and the messaging comprising the 4-way key exchange may occur over link B. As can be appreciated, in this particular scenario, portions (sub-operations) of the association procedure, e.g., the exchange of probe messages occurs on a first link, i.e., link A, while the remainder of the association procedure (sub-operations including the association request/response and 4-way key exchange) occur over link B. Therefore, like conventional MLO, data frames can be exchanged across multiple links (not just a single link), but unlike conventional MLO, non-AP MLDs are prevented (or the likelihood is prevented) from attempting to associate to the same (single) link.

FIG. 6D illustrates a scenario where beacon 600, probe response 604, and association response 608 may be transmitted by AP 210 on link A. Beacon 600, probe response 604, and association response 608 each include a link recommendation in the Link ID subfield, recommending a link for use, in this instance, link B. In this scenario, probe request 602 and probe response 604 may also include a link recommendation to a particular link, again, link B. Here, the messaging comprising the 4-way key exchange may occur over link B pursuant to the link recommendation that recommends link B for association procedures. As can be appreciated, again, in this particular scenario, portions (sub-operations) of the association procedure, e.g., the exchange of probe amd association messages occurs on a first link, i.e., link A, while the remainder of the association procedure (sub-operations including the 4-way key exchange) occur over link B. Therefore and again, like conventional MLO, data frames can be exchanged across multiple links (not just a single link), but unlike conventional MLO, non-AP MLDs are prevented (or the likelihood is reduced) from attempting to associate to the same (single) link.

It should be noted that the above examples may be extrapolated for use in other frame exchanges, such as, but not limited to, e.g., reassociation of a non-AP MLD to the same AP MLD, roaming association of a non-AP MLD to a neighbor AP MLD, roaming reassociation to a neighboring AP MLD. That is, broadly speaking, examples of the disclosed technology recommends a link over which data frames can be exchanged, the data frames pertaining to management-level procedures occurring at the MLD device-level (i.e., a higher level that spans lower 802.11 media access control (MAC) functions (that handle frame aggregation, channel access, etc.) across links/bands). That is, in prior Wi-Fi® generations/versions, a per-link management entity resided in a device (AP or client), but with the advent of MLO, there is only a single management entity for all a device's links.

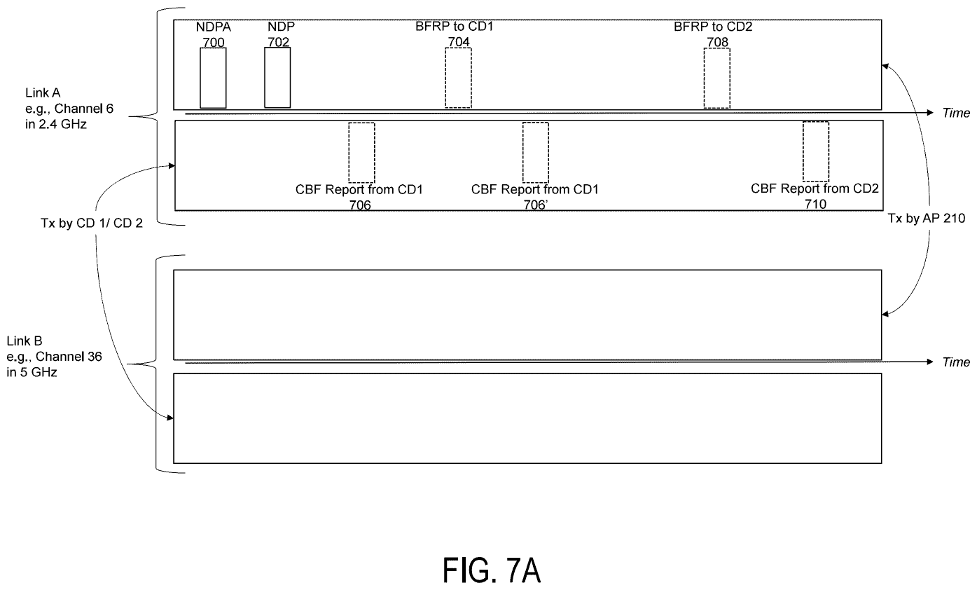

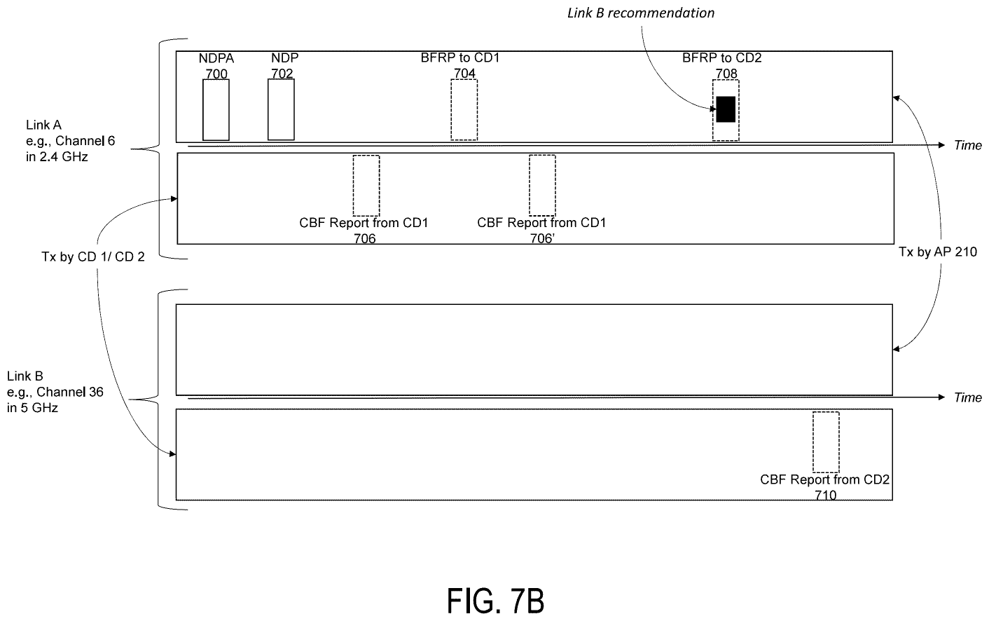

FIG. 7A illustrates another example of a typical frame exchange, in this case, a transmit beamforming feedback frame exchange. Generally, inclusion of a link recommendation in specific frames implies/suggests use of a particular link for exchanging frames related to the link local function, including but not limited to, e.g., radio resource management, transmit beamforming, etc.

As with previously-discussed examples, links between the AP 210 and the client device 220 are illustrated, i.e., links A and B. Link A may correspond to the 2.4 GHz frequency band which is used for communication between the 2.4 GHz radios of the AP 210 and the client device 220 (see, FIG. 2), and in the illustrated example, a particular channel, channel 6, may be used in the 2.4 GHz frequency band. Link B may correspond to the 5 GHz frequency band which is used for communication between the 5 GHz radios of the AP 210 and client device 220, and in particular, channel 36 of the 5 GHz frequency band. It should be understood that the specific channel used for communications need not be limited to a specific channel(s). Again, examples of the disclosed technology are premised on a recommended link, rather than channels of a link.

In some embodiments, AP 210 may be an AP that initiates a channel sounding procedure such as that specified in Wi-Fi 6 (802.11ax), whereby a transmitter and a receiver determine characteristics of a communication channel between them such that the transmitter is able to then act as a beamformer and direct transmissions to the receiver (beamformee) in accordance with a spatial transmission pattern that is optimized with respect to the channel characteristics. Generally speaking, beamforming refers to the capability of a device to shape/steer/direct its transmitted frames to one or more receivers. A device with such a capability is called a beamformer, while a receiver of such frames is a beamformee. Beamforming depends on channel calibration procedures, referred to as channel sounding in Wi-Fi 6.

The channel sounding protocol specified in Wi-Fi 6 begins with a transmitter broadcasting a probe signal that is received by a receiver. The receiver calculates feedback information based on various channel measurements and sends the feedback information to the transmitter. The transmitter then uses the feedback information to calculate a steering matrix, which (acting as a beamformer) it applies to transmitted signals to optimize reception at one or more receivers (beamformees). More specifically, the transmitter uses the steering matrix to determine the appropriate weights/phase shifts to apply to its antennas in order to direct/steer transmitted energy to a receiver along a precisely determined spatial path which is designed, for example, to maximize the signal-to-noise (SNR) ratio at the receiver.

FIG. 7A illustrates AP 210 transmitting a null data packet announcement (NDPA) 700, and a null data packet (NDP) 702 on link A. That is, and to begin the channel sounding process, AP 210 sends NDPA 700 followed by NDP 702, where NDPA 700 indicates to CD1 that AP 210 will transmit an NDP, i.e., NDP 702, after NDPA 700. Client device CD1 receives NDP 702, analyzes NDP 702, and computes a feedback matrix. The feedback matrix is sent in reply to NDP 702 in the form of a compressed beamforming report (CBF Report 706), which helps the beamformer (AP 210) learn a direction in which frames could be steered to the beamformee (CD1). Typically, as illustrated in FIG. 7A, such messaging/frame exchange occurs on a single link, in this example, link A. Such a scenario may apply to a single non-AP MLD, i.e., CD1, that is associated to AP MLD 210.

FIG. 7A illustrates another example scenario, where the beamforming procedure involves retrieving the feedback matrix from CD1 using a beamforming report poll (BFRP) frame. Similar to the example of FIG. 7A, described above, to begin the channel sounding process, AP 210 sends NDPA 700 followed by NDP 702. In addition, AP 210 also sends BFRP 704 to CD1. CD1 receives NDP 702, analyzes NDP 702, and computes a feedback matrix. The feedback matrix is sent in reply to BFRP 704 vis-à-vis CBR 706′, which again, helps the beamformer (AP 210) learn a direction in which frames could be steered to the beamformee (CD1).

FIG. 7A illustrates yet another example, where multiple client devices, in this example, CD1 and CD2 are associated to AP 210. In such a scenario, similar to the example of FIG. 7B, described above, to begin the channel sounding process, AP 210 sends NDPA 700 followed by NDP 702. In addition, AP 210 also sends BFRP 704 to CD1. CD1 receives NDP 702, analyzes NDP 702, and computes a feedback matrix. The feedback matrix is sent in reply to BFRP 704 vis-à-vis CBR 706′. Additionally, in this scenario, a second BFRP frame 708 can be sent to CD2 in order to retrieve beamforming feedback. Accordingly, CD2 also sends a CBF report 710 in response to second BFRP frame 708. In this example scenario, multiple non-AP MLDs (CD1 and CD2) are associated to AP 210.

FIG. 7B illustrates how data frames can be exchanged between a client device/non-AP MLD and an AP MLD over multiple links in accordance with some examples of the disclosed technology. In this scenario, as described above, multiple client devices, in this example, CD1 and CD2 are associated to AP 210. To begin the channel sounding process, AP 210 sends NDPA 700 followed by NDP 702. In addition, AP 210 also sends BFRP 704 to CD1. CD1 receives NDP 702, analyzes NDP 702, and computes a feedback matrix. The feedback matrix is sent in reply to BFRP 704 vis-à-vis CBR 706′. A second BFRP frame 708 can be sent to CD2 in order to retrieve beamforming feedback. Accordingly, CD2 also sends a CBF report 710 in response to second BFRP frame 708. However, unlike the last-described scenario reflected by FIG. 7A, as illustrated in FIG. 7B, a link recommendation recommending use of link B is included in the BFRP 708 sent by AP 210 to CD2. Accordingly, upon receipt of such a link recommendation, CD2 may utilize recommended link B to transmit data frames making up the CBF report 710 from CD2 to AP 210.

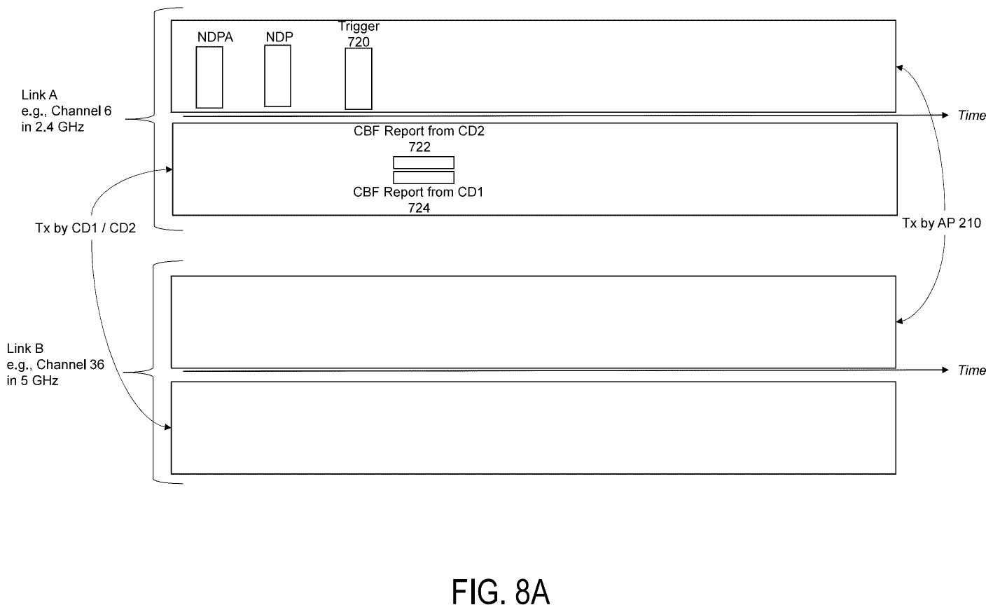

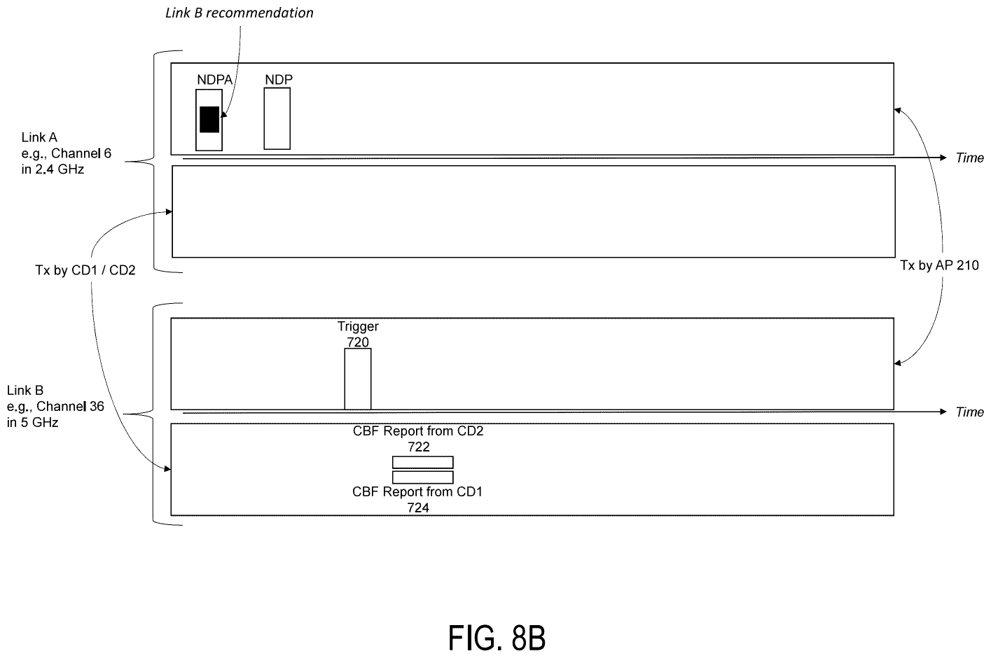

FIG. 8A illustrates a scenario, where again, multiple client devices, in this example, CD1 and CD2, are associated to AP 210. In such a scenario, to begin the channel sounding process, AP 210 sends NDPA 700 followed by NDP 702. In addition, AP 210 also sends a trigger frame 720. Trigger frame 720 enables AP 210 to initially sync and subsequently re-sync its timing, carrier frequency offset (CFO), and phase, including sounding, and any transmissions thereafter. In response to trigger frame 720 (and NDPA 700/NDP 702), CD1 and CD2 sent CBF reports 724 and 722, respectively, to AP 210.

FIG. 8B illustrates the same scenario as that illustrated in FIG. 8A, but with one example of the disclosed technology applied, where a recommended link, in this example, link B, is included in NDPA frame 700. Upon receipt of NDPA 700 by CD1 and CD2 (which expect trigger 720 to come on Link B), can exchange their respective CBF reports 722 and 724 over Link B. It should be noted that there can be multiple types of client/non-AP MLDs some of which can support full simultaneous transmit-receive and non-simultaneous transmit-receive scenarios. Thus, the link recommendation sent as part of an NDPA frame can be leveraged such that the recommended link can be used for exchanging link-local information (e.g., address information used for communications within some logical division of a communications network) on a link that is a part of MLO. In other words, the link is included in the multi-link operation between the client MLD and the AP MLD. Consider, for example, a tri-band, tri-link AP MLD having 2.4, 5, and 6 GHz radios, where a non-AP MLD only sets up/establishes two links (because the non-AP MLD is dual-link capable (e.g., 2.4 GHz and 5 GHz), rather than tri-link capable with the AP MLD under MLO. In this example, the 2.4 GHz link would be a part of MLO and the 6 GHz would not be a part of MLO.

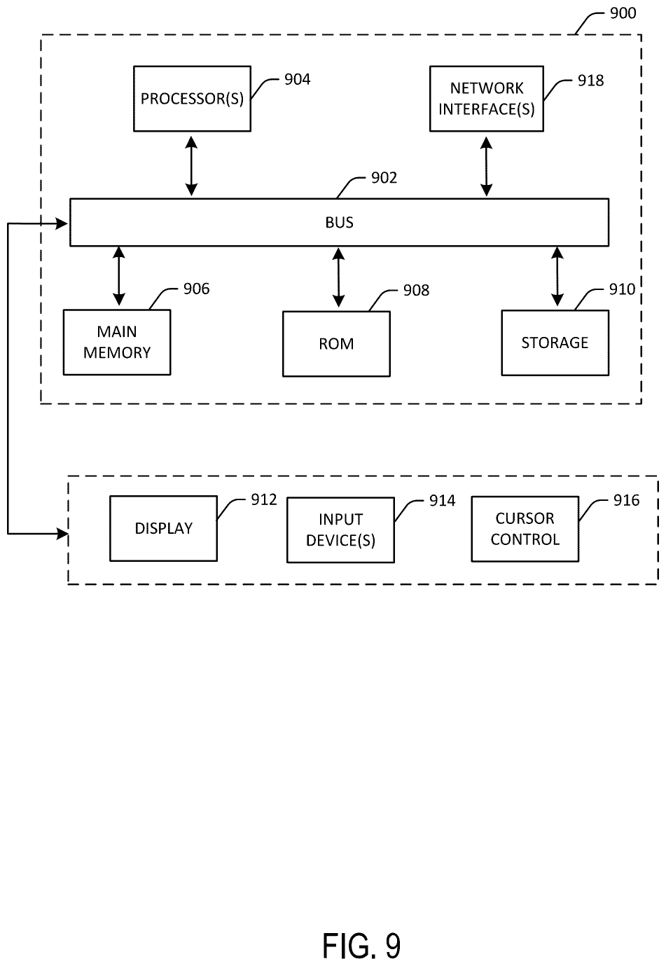

FIG. 9 depicts a block diagram of an example computer system 900 in which various of the embodiments described herein may be implemented. The computer system 900 includes a bus 902 or other communication mechanism for communicating information, one or more hardware processors 904 coupled with bus 902 for processing information. Hardware processor(s) 904 may be, for example, one or more general purpose microprocessors.

The computer system 900 also includes a main memory 906, such as a random access memory (RAM), cache and/or other dynamic storage devices, coupled to bus 902 for storing information and instructions to be executed by processor 904. Main memory 906 also may be used for storing temporary variables or other intermediate information during execution of instructions to be executed by processor 904. Such instructions, when stored in storage media accessible to processor 904, render computer system 900 into a special-purpose machine that is customized to perform the operations specified in the instructions.

The computer system 900 further includes a read only memory (ROM) 908 or other static storage device coupled to bus 902 for storing static information and instructions for processor 904. A storage device 910, such as a magnetic disk, optical disk, or USB thumb drive (Flash drive), etc., is provided and coupled to bus 902 for storing information and instructions.

The computer system 900 may be coupled via bus 902 to a display 912, such as a liquid crystal display (LCD) (or touch screen), for displaying information to a computer user. An input device 914, including alphanumeric and other keys, is coupled to bus 902 for communicating information and command selections to processor 904. Another type of user input device is cursor control 916, such as a mouse, a trackball, or cursor direction keys for communicating direction information and command selections to processor 904 and for controlling cursor movement on display 912. In some embodiments, the same direction information and command selections as cursor control may be implemented via receiving touches on a touch screen without a cursor.

The computing system 900 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 900 may implement the techniques described herein using customized hard-wired logic, one or more ASICs or FPGAs, firmware and/or program logic which in combination with the computer system causes or programs computer system 900 to be a special-purpose machine. According to one embodiment, the techniques herein are performed by computer system 900 in response to processor(s) 904 executing one or more sequences of one or more instructions contained in main memory 906. Such instructions may be read into main memory 906 from another storage medium, such as storage device 910. Execution of the sequences of instructions contained in main memory 906 causes processor(s) 904 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 910. Volatile media includes dynamic memory, such as main memory 906. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 902. Transmission media can also take the form of acoustic or light waves, such as those generated during radio-wave and infra-red data communications.

The computer system 900 also includes a communication interface 918 coupled to bus 902. Communication interface 918 provides a two-way data communication coupling to one or more network links that are connected to one or more local networks. For example, communication interface 918 may be an integrated services digital network (ISDN) card, cable modem, satellite modem, or a modem to provide a data communication connection to a corresponding type of telephone line. As another example, communication interface 918 may be a local area network (LAN) card to provide a data communication connection to a compatible LAN (or WAN component to communicated with a WAN). Wireless links may also be implemented. In any such implementation, communication interface 918 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 918, which carry the digital data to and from computer system 900, are example forms of transmission media.

The computer system 900 can send messages and receive data, including program code, through the network(s), network link and communication interface 918. In the Internet example, a server might transmit a requested code for an application program through the Internet, the ISP, the local network and the communication interface 918.

The received code may be executed by processor 904 as it is received, and/or stored in storage device 910, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAS, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 900.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A non-access point multi-link device (AP MLD) comprising:
one or more processors; and
a machine readable storage medium storing instructions that, when executed by the one or more processors, cause the non-AP MLD to:
receive a beacon from an AP MLD;
extract from the beacon, information regarding recommended links over which to exchange data frames with the AP MLD and non-recommended links over which the exchange of data frames with the AP MLD is to be avoided;
initiate an association process to associate the non-AP MLD to the AP MLD using a recommended link of the extracted recommended links; and
establish a connection over the recommended link for exchanging the data frames between the AP MLD and the non-AP MLD.

2. The non-AP MLD of claim 1, wherein the information extracted from the beacon comprises an information element including a link-specific subfield carrying information specific to a link of the AP MLD.

3. The non-AP MLD of claim 2, wherein the information element further includes a recommendation indicator applicable to the link specified in the link-specific subfield indicating whether the link is recommended for the exchange of data frames with the AP MLD or whether the link is not recommended for the exchange of data frames with the AP MLD.

4. The non-AP MLD of claim 2, wherein the information extracted from the beacon comprises a multi-link element (MLE).

5. The non-AP MLD of claim 4, wherein the MLE further comprises a Link ID subfield carrying information specific to a link of the AP MLD, including an indicator indicating whether the link is recommended for use by the non-AP MLD for either the association process to associate the non-AP MLD to the AP MLD or a multi-link setup process between the non-AP MLD and the AP MLD.

6. The non-AP MLD of claim 1, wherein the instructions that when executed cause the non-AP MLD to initiate the association process further causes the non-AP MLD to perform at least one subset of operations comprising the association process over the recommended link and at least one subset of operations comprising the association process over another link other than the recommended link.

7. The non-AP MLD of claim 1, wherein the machine readable storage medium stores further instructions that, when executed by the one or more processors, cause the non-AP MLD to perform at least a subset of a multi-link setup process using the recommended link.

8. An access point multi-link device (AP MLD) comprising:
one or more processors; and
a machine readable storage medium storing instructions that, when executed by the one or more processors, cause the AP MLD to:
transmit a beacon including information regarding recommended links over which to exchange data frames between the AP MLD and a non-AP MLD, and non-recommended links over which the exchange of data frames between the AP MLD and a non-AP MLD is to be avoided;
engage in an association process to associate the non-AP MLD to the AP MLD using a recommended link of the recommended links; and
establish a connection over the recommended link for exchanging the data frames between the AP MLD and the non-AP MLD.

9. The AP MLD of claim 8, wherein the information included in the beacon comprises an information element including a link-specific subfield carrying information specific to a link of the AP MLD.

10. The AP MLD of claim 9, wherein the information element further includes a recommendation indicator applicable to the link specified in the link-specific subfield indicating whether the link is recommended for the exchange of data frames between the AP-MLD and the non-AP MLD or whether the link is not recommended for the exchange of data frames between the AP MLD and the non-AP MLD.

11. The AP MLD of claim 9, wherein the information element comprises a multi-link element (MLE).

12. The AP MLD of claim 11, wherein the MLE further comprises a Link ID subfield carrying information specific to a link of the AP MLD, including an indicator indicating whether the link is recommended for use by the non-AP MLD for either the association process to associate the non-AP MLD to the AP MLD or a multi-link setup process between the non-AP MLD and the AP MLD.

13. The AP MLD of claim 8, wherein the instructions that when executed cause the AP MLD to engage in the association process further causes the AP MLD to perform at least one subset of operations comprising the association process over the recommended link and at least one subset of operations comprising the association process over another link other than the recommended link.

14. The AP MLD of claim 8, wherein the machine readable storage medium stores further instructions that, when executed by the one or more processors, cause the AP MLD to perform at least a subset of a multi-link setup process using the recommended link.

15. An access point multi-link device (AP MLD) comprising:
one or more processors; and
a machine readable storage medium storing instructions that, when executed by the one or more processors, cause the AP MLD to:
transmit a beacon including information regarding recommended links over which to exchange data frames between the AP MLD and a non-AP MLD, and non-recommended links over which the exchange of data frames between the AP MLD and a non-AP MLD is to be avoided;
engage in an association process to associate the non-AP MLD to the AP MLD using a recommended link of the recommended links; and
establish a connection over a recommended link of the recommended links for exchanging the data frames between the AP MLD and the non-AP MLD.

16. The AP MLD of claim 15, wherein the information included in the beacon comprises an information element including a link-specific subfield carrying information specific to a link of the AP MLD.

17. The AP MLD of claim 16, wherein the information element further includes a recommendation indicator applicable to the link specified in the link-specific subfield indicating whether the link is recommended for the exchange of data frames between the AP-MLD and the non-AP MLD or whether the link is not recommended for the exchange of data frames between the AP MLD and the non-AP MLD.

18. The AP MLD of claim 17, wherein the information element comprises a multi-link element (MLE).

19. The AP MLD of claim 18, wherein the MLE further comprises a Link ID subfield carrying information specific to a link of the AP MLD, including an indicator indicating whether the link is recommended for use by the non-AP MLD for the establishment of the connection, the establishment of the connection comprising a multi-link setup process between the non-AP MLD and the AP MLD.

20. The AP MLD of claim 15, wherein the machine readable storage medium stores further instructions that, when executed by the one or more processors, cause the AP MLD to perform at least a subset of a multi-link setup process using the recommended link.
